(19) United States
(12) Patent Application Publication
(10) Pub. No.: US 2010/0056300 A1
(43) Pub. Date: Mar. 4, 2010

(54) MUTLI-LAYER GOLF BALL HAVING INNER COVERS WITH NON-PLANAR PARTING LINES

(76) Inventors: Scott Cooper, Warwick, RI (US); Douglas E. Jones, Dartmouth, MA (US); Matthew F. Hogge, Plymouth, MA (US); Herbert C. Boehm, Norwell, MA (US)

Correspondence Address: ACUSHNET COMPANY, 333 BRIDGE STREET, P. O. BOX 965, FAIRHAVEN, MA, 02719, US

(21) Appl. No.: 12/198,490

(22) Filed: Aug. 26, 2008

(51) Int. Cl. A63B 37/00; B29C 45/16

(52) U.S. Cl. 473/374; 264/250

(57) ABSTRACT

The invention comprises a golf ball. The golf ball is formed with a core, at least one intermediate layer, and a cover. The intermediate layer has a non-planar parting line. The molds used to form the intermediate layer have non-planar mating surfaces. The non-planar mating surfaces of the molds mesh, and when the intermediate layer is formed therein, the intermediate layer has a non-planar parting line thereon. If compression molding is used, hemispherical layer blanks may be pre-formed in the shape of the mold halves. To form the intermediate layer, the two blanks are compression molded together. If injection molding is used, a core is placed inside a mold chamber and layer material is injected into the mold chamber to form the intermediate layer about the core. If reaction injection molding is used, two or more reactive precursors are mixed and injected into the mold cavity, and they react to form the intermediate layer. Optional outer layers and a cover are molded on the intermediate layer to form a finished ball.

### FIELD OF THE INVENTION

The invention relates to golf balls, and more particularly, the invention is directed to golf balls having an intermediate layer, wherein the intermediate layer has a non-planar parting line.

### BACKGROUND OF THE INVENTION

Conventional golf balls can be divided into several general classes: (a) solid golf balls having one or more layers, and (b) wound golf balls. Solid golf balls include one-piece balls, which are easy to construct and relatively inexpensive, but have poor playing characteristics and are thus generally limited for use as range balls. Two-piece balls are constructed with a generally solid core and a cover and are generally popular with recreational golfers because they are very durable and provide maximum distance. Balls having a two-piece construction are commonly formed of a polymeric core encased by a cover. Solid golf balls also include multi-layer golf balls, which are comprised of a solid core of one or more layers and/or a cover of one or more layers. Many of these multi-layer golf balls also include one or more intermediate layers of varying characteristics. These balls are regarded as having an extended range of playing characteristics, and, based on the characteristics of the individual layers, and the differences between layers, these balls may be customized to particular styles of play.

There are several methods by which multi-layer golf balls are traditionally made. A core is generally prepared first, by any method known in the art. An intermediate layer is generally molded about the core. This process is usually accomplished by compression molding, injection molding, reaction injection molding (RIM), or casting. A cover is likewise molded over the intermediate layer, usually by one of the above listed processes. Alternatively, an intermediate layer can be formed first, and a fluid core or reactive mixture that will form a core is injected within the intermediate layer.

A compression molding operation is often accomplished using a pair of substantially hemispherical mold halves. Two substantially hemispherical layer blanks are placed in diametrically opposing positions on the golf ball core or core and optional inner layers (hereinafter the “golf ball subassembly”), and the golf ball subassembly with the hemispherical blanks thereon is placed in the substantially hemispherical mold halves, and then subjected to a compression molding operation. The compression molding operation comprises placing the blanks disposed about the golf ball subassembly under high heat and pressure. The combination of heat and pressure applied during the molding operation results in the cover blanks being fused to the golf ball subassembly and to each other to form a unitary golf ball precursor. The parting line, also know as the seam, of a layer is represented by the visible artifact left on the layer after a molding operation is complete, formed by softened layer material passing into the space defined by the opposing mating surfaces of the mold halves. The parting line also coincides with the plane at which the two mold blanks fuse to form the layer. For ease of manufacturing, the opposing mating surfaces of the mold halves are machined flat and perpendicular to the golf ball subassembly surface as to provide a positive shut off, thereby preventing softened intermediate layer material from leaking out of the mold. As the blanks are placed under heat and pressure, the material from each blank softens and mixes with the material from the other blank at the contact surface between the two blanks. While the material at the juncture of the two blanks mixes enough to form a solid layer, the mixing may not be complete. The polymers that hold the layer together may not become as firmly entangled at the connection of the blanks as they are elsewhere in each blank. This can create an area of relative weakness at the juncture of the two blanks. Because the weakest point in a layer is at this binding plane, a ball made by such a process may fail at that plane when hit.

An injection molding operation is likewise accomplished using a pair of substantially hemispherical mold halves. The substantially hemispherical mold halves comprise gates, which allow heated, viscous thermoplastic polymeric material intended to for the layer to pass into the mold, and vents, which allow trapped air and gases to escape from the mold. The mold halves may also have holes therein where retractable pins may be disposed to hold the core or subassembly about which the layer is to be formed centered within the spherical mold cavity. When retractable pins are used, the operation is considered a retractable pin injection molding (RPIM) process. A RPIM operation is carried out by placing the golf ball subassembly in the mold halves, and securing the golf ball subassembly in the center of the spherical cavity defined by the mold halves using the retractable pins. Alternatively, the mold may use “deep dimples” to hold the subassembly in place. The layer material is injected into the spherical cavity through the gates and trapped air and gases escape through the vents. When the mold is filled with layer material such that the golf ball subassembly has stabilized within the layer material, the retractable pins are retracted, and the layer material flows into and fills the space vacated by the retractable pins. After the mold is completely filled with layer material, the layer material is allowed to harden. The mold is then opened, and the molded golf ball precursor is ejected, either via ejector pins, or by any method known in the art.

When a golf ball layer is formed by an injection molding process with multiple gates for injection of layer material, the layer material from a gate eventually intersects with the layer material injected via a neighboring gate. Knit lines are formed at the intersection of the converging flow fronts. Depending on the composition of the layer material, the material strength can be reduced by as much as 10% to 60% along the knit lines. Thus, because the layer is inherently weaker along the knit lines, a ball is more likely to fail at a knit line when hit. In a conventional RPIM system, gates are placed at the intersection between the mold halves, and the vents are placed at the poles of the mold. In this configuration, the knit lines will span the layer from pole to pole, with one knit line between each set of adjacent gates, with all of the knit lines meeting at the vents. In an improved configuration, the gates are placed at the poles, and the vents are located at or near the parting line of the mold. This allows trapped air and gases to vent quickly due to the larger area around the parting line for venting. This configuration also allows the minimization of knit lines, and the restriction of knit lines to the area of the parting line, because the converging flow fronts of the layer material will meet near the mold parting line, creating a single knit line encircling the equator of the layer. While this set-up reduces the impact of knit lines throughout much of the layer, a golf ball formed with such a knit line, is still more likely to fail along the knit line. There is therefore a need to increase the strength of the bonding between the layer material in the two flow fronts, to increase the overall durability of a ball having layers formed in this manner.

In a RIM process, two hemispherical mold halves are mated to form a spherical cavity, with a golf ball subassembly disposed therein. Two or more highly reactive liquid thermoset precursors are mixed, such as with a peanut mixer and/or an inpingement mix head, and the precursors immediately begin to react. The mixture is quickly injected into the mold cavity. Gas trapped within the mold cavity escapes through vents as the mold cavity area surrounding the golf ball subassembly fills with reactive liquid mixture. As the reaction procedes, the layer of liquid mixture surrounding the subassembly solidifies to form a unitary solid generally thermoset layer about the subassembly. The layer is allowed to cool as the solidification continues, and the layer hardens. Eventually, after the layer is sufficiently hard, the mold may be opened and the golf ball precursor may be removed from the mold for further processing or the formation of subsequent layers thereon.

U.S. Pat. No. 6,663,508 issued to Keller, et. al. discloses using a RIM system to form a golf ball intermediate layer or cover. This system mixes the precursors as they are being passed into the layer mold through a single gate, and the components react within the mold to form a solid thermoset layer. This has the advantage of removing knit lines in the layer completely, because the mixture reacts after it has formed a full layer about the golf ball subassembly. Furthermore, a thermoset cover layer, such as a polyurethane or polyurea layer, can improve golf ball performance.

U.S. Pat. No. 6,797,097 issued to Boehm, et. al. discloses pre-forming mold blanks and sealing them with adhesive to form an intermediate layer. The adhesive may have a strength higher than that of the layer material.

A need exists for a method of making a golf ball with an increased strength at the binding plane where the sections or segments of the intermediate layer are joined to increase the ball's overall durability, while still allowing the intermediate layer to be formed of a great variety of components, and allowing the ball to have consistent performance.

### SUMMARY OF THE INVENTION

The present invention is directed to a multi-layer golf ball having at least an inner core, an outer cover, and at least one intermediate layer or inner cover or outer core layer between the inner core and the outer cover. The intermediate layer comprises a non-planar parting line, at which line at least two segments of the layer were joined in the molding process. In particular, the method of making a multi-layer golf ball utilizes injection molding, compression molding, or RIM to form the intermediate layer. Preferably, the outer cover is also made from one of these molding techniques and has a planar parting line.

In one embodiment of the present invention, the golf ball comprises a cover and a dual core, having an inner core and an outer core. The outer core is the intermediate layer, which has been molded with a non-planar parting line.

In another embodiment, the golf ball comprises a core and a dual cover, having an inner cover layer, and an outer cover. The intermediate layer is the inner cover and has been molded with a non-planar parting line.

Another embodiment teaches the making of a golf ball comprising a core, a cover, and an intermediate mantle disposed between the core and the cover. The intermediate mantle has been molded with a non-planar parting line.

In another embodiment, the invention comprises using a mold for making a golf ball intermediate layer. The mold comprises two mold halves, each mold half defining a substantially hemispherical cavity. Each mold half has a rim with indentations and protrusions on the rim. When the mold halves are mated together, a spherical cavity is defined therebetween, and the protrusions on the rim of the first mold half align with the indentations in the rim of the second mold half, and the protrusions on the rim of the second mold half align with the indentations in the rim of the first mold half. The protrusions and indentations on the rims of the two mold halves are arranged such that, on the surface which defines the spherical cavity, the mold parting line defined by the mating of the two mold halves is non-planar. In another embodiment, the mold has vents, and preferably, the vents are located on or proximate to the non-planar mold parting line

### BRIEF DESCRIPTION OF THE DRAWINGS

Further features and advantages of the invention can be ascertained from the following detailed description that is provided in connection with the drawings described below:

FIGS. 1A to 1C are views of a golf ball of the present invention with the intermediate layer having a several shapes of non-planar parting lines shown within the cover, which has a planar parting line.

FIGS. 1D to 1E are view of a golf ball as in FIG. 1A, except that the intermediate layer parting line is misaligned with the cover parting line.

FIGS. 2 and 3 are cross-sectional view of view of a golf ball of the present invention across lines 1A and 1B of FIG. 1 respectively.

FIG. 4A is a perspective view of a mold that could be used in practicing the present invention.

FIG. 4B is a cross-sectional view of a mold of the present invention wherein the two mold halves have been mated.

FIG. 5 is a perspective view of a layer blank that could be used in making a golf ball of the present invention.

FIG. 6 is a side view of a mold for pre-forming a single blank that could be used in making a golf ball of the present invention.

FIG. 7 is a side view of a mold for pre-forming a pair of blanks that could be used in making a golf ball of the present invention.

FIG. 8A is a cross-sectional view of an injection mold forming an intermediate layer of the current invention on an golf ball subassembly.

FIG. 8B to E are perspective views of a golf ball of the present invention wherein the formation of an intermediate layer is illustrated and the location and arrangement of vents and gates on the mold used to make the intermediate layer are indicated.

FIGS. 9 and 10 are charts of experimental data comparing durability of prototypes of the current invention to currently marketed golf balls. FIG. 9 illustrates the performance of individual NXT Tour and Prototype golf balls. FIG. 10 is a box and whisker plot which indicates the median, first and third quartile, minimum and maximum cycles to failure of the tested NXT Tour and Prototype golf balls.

### DETAILED DESCRIPTION

The present invention relates to multi-layer golf balls, having a core, at least one intermediate layer disposed concentrically adjacent to the core, and an outer cover. The intermediate layer can be an inner cover layer, an outer core layer, or a mantle layer. The invention also relates to golf balls having a double core, a multi-layer core, a double cover, a multi-layer cover or more than one intermediate layer. The intermediate layer is formed with a non-planar parting line, at which line at least two segments of the layer are joined in the molding process, and preferably, the outer cover has a planar parting line. In particular, the invention relates to methods of making the golf balls described, by injection molding, compression molding or reaction injection molding.

In compression molding, generally, a golf ball subassembly is inserted into the spherical cavity of a two-piece mold, and pre-sized blanks of layer material are placed in each half of the mold. The mold is closed and heat and pressure are applied to mold the layer material about the subassembly. Compression molding is generally performed using either thermoplastic polymeric materials, such as minimally cross-linked polyurethanes or polyureas or semi-cured thermosetting polymeric materials, such as cross-linked polyurethanes or polyureas. When the layer cools, the ball subassembly with new layer may be ejected from the mold.

In injection molding, a golf ball subassembly is trapped in place in the spherical cavity of a mold. Heated, viscous molten thermoplastic polymeric layer material is injected into the mold cavity under high heat and pressure, usually from a plurality of gates either about the equator, or at the poles of the mold cavity. As the layer material, generally a thermoplastic, such as minimally cross-linked polyurethanes or polyureas, fills the mold cavity, trapped air and gases escape from the cavity from a plurality of vents, generally placed at whichever of the equator or the poles of the mold that the gates are not. When the mold cavity has filled with layer material, the material is allowed to cool to form a solid layer, and the subassembly and new layer may be removed from the mold.

In reaction injection molding, a golf ball subassembly is trapped in place in the spherical cavity of a mold. Two layer material precursors, often a low molecular weight polyether or polyester having numerous hydroxyl, amine, amide, or other reactive functional groups, and a multifunctional isocyanate, are mixed, either in a mixing chamber, an in-line mixer, or within the mold cavity itself. If the precursors are mixed outside the mold cavity, the mixture is quickly injected into the mold chamber, where the precursors polymerize and crosslink to form a solid thermoset layer. After the layer has polymerized sufficiently, the ball subassembly and new layer may be removed from the mold.

Each of the molding processes generally uses with a different type of material. Injection molding is performed using almost solely thermoplastics. Compression molding works both with thermoplastics and with semi-cured thermosets. Reaction injection molding begins with thermoset precursors, and forms a thermoset as those precursors react and cure.

A thermoplastic material is a polymer that can be melted after it has hardened. These polymers generally have limited cross-linking between chains. Thermoplastics are the most common type of plastic, and include many subcatagories, such as ionomers, including high acid and low acid ionomers, multiple cation ionomers, non-ionomers, polyurethanes, polyureas, polyvinyls, polyolefins, polystyrenes, metallocene polymers, and blends of all of the above, among many others.

A thermoset material is a polymer that cannot be melted after it has hardened, or set. These polymers are heavily crosslinked, such that the individual chains may not easily move past one and other, even under increased heat. Thermosets are less common than thermoplastics, and the most common are crosslinked polyurethanes and polyureas, such as balata, or cross-linked silane plastics

In the manufacture of a golf ball, it is important that the mating surfaces of the molds mate precisely. This minimizes the amount of flash and other parting line artifacts, which produces greater uniformity and control over the size, weight, and roundness of the ball. Conventional golf ball molds employ a planar parting surface to easily provide a very precise mate, and because it is far easier to machine molds having planar parting lines. However, a planar parting line on the molded layer minimizes the length of the parting line, and provides a linear outlet for excess layer material, which can create imperfections and weakness in the bond between the layer blanks or along knit lines. This may manifest itself as reduced durability of the ball to strikes with a golf club.

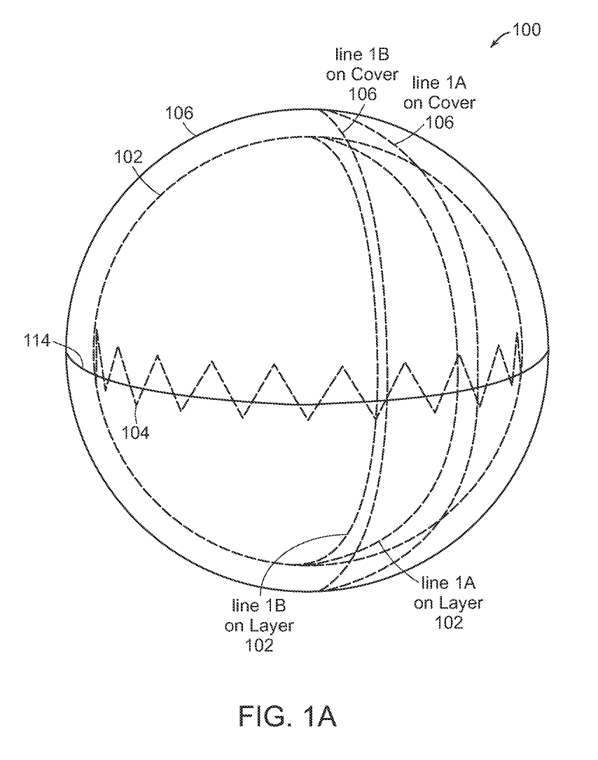

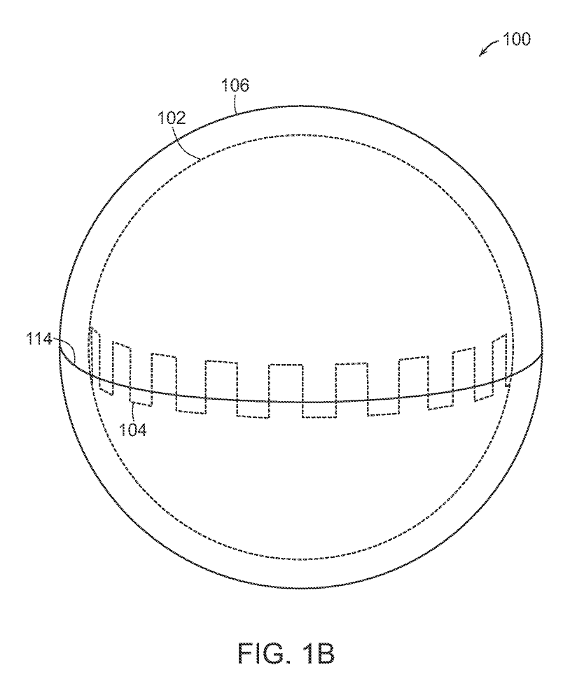

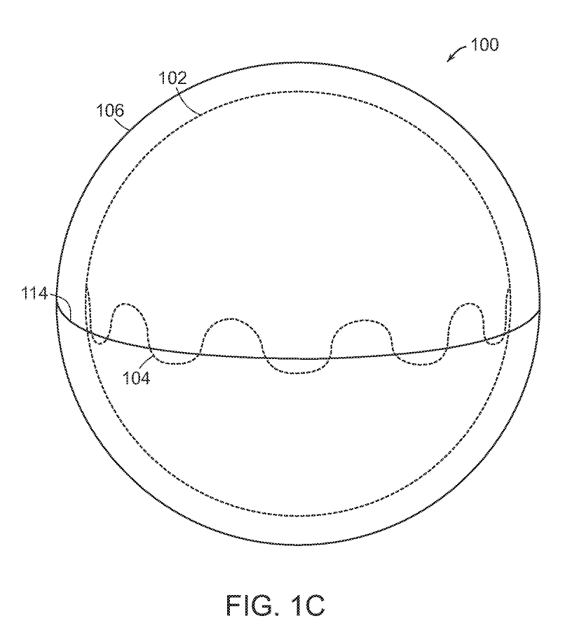

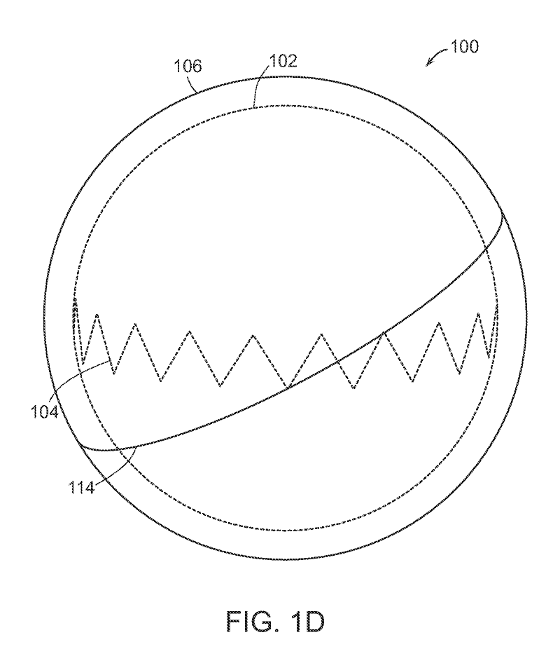

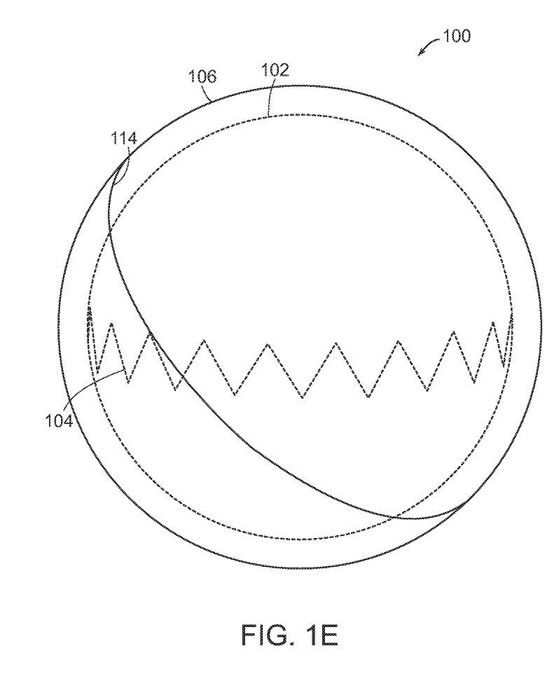

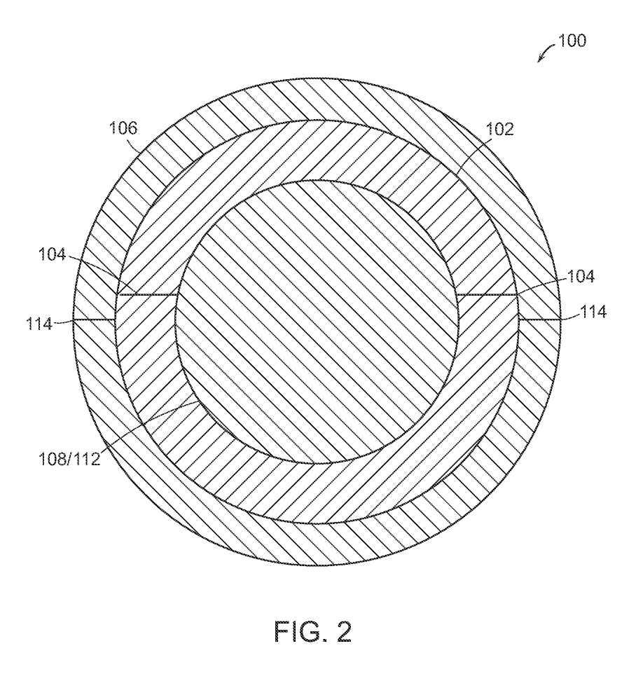

FIG. 1A illustrates a golf ball 100 of the present invention. Golf ball 100 has an intermediate layer 102. Intermediate layer 102 has a parting line 104 thereon. In this embodiment, parting line 104 has a saw-tooth shape. Golf ball 100 also has a cover 106, and cover 106 has a cover parting line 114. In this embodiment cover parting line 114 is planar, and is aligned with intermediate layer parting line 104. As intermediate layer parting line 104 transcribes intermediate layer 102, it passes both above and below the plane defined by aligned cover parting line 114.

FIG. 1B illustrates another embodiment of a golf ball 100 of the present invention. Golf ball 100 has an intermediate layer 102 and a cover 106, each having a parting line 104 and 114 respectively, as in FIG.1A, except that intermediate layer parting line 104 in this embodiment has a square-wave shape. Cover parting line may also be non-planar.

FIG. 1C illustrates yet another embodiment of a golf ball 100 of the present invention. Golf ball 100 has an intermediate layer 102 and a cover 106, each having a parting line 104 and 114 respectively, as in FIGS. 1A and 1B, except that intermediate layer parting line 104 in this embodiment has a sinusoid shape.

Non planar parting line 104 can take any of a number of forms, including sinusoidal, as in FIG. 1C, saw-toothed, as in FIG 1A, or square-wave, as in FIG. 1B, along with numerous variations thereof that would be obvious to one of skill in the art, including biasing the non-planar shapes along an arcuate line, or along a sinusoidal line, varying the periodicity of the non-planar repetitions, utilizing non-repetitious non-planar shapes, mixing non-planar shapes, including planar segments within the non-planar shapes, or any combination thereof.

FIGS. 1D and 1E show other embodiment of golf balls 100 of the present invention. Golf balls 100 of these embodiments are identical to golf ball 100 in FIG. 1A except that in these embodiments, cover parting lines 114 are misaligned with intermediate layer parting lines 104.

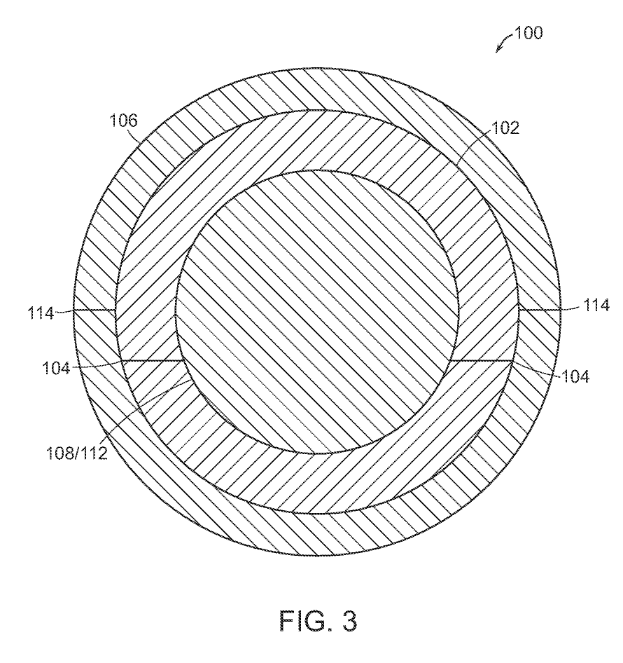

FIG. 2 illustrates a cross-sectional view of golf ball 100 of FIG. 1A across line 1A. Golf ball 100 includes, in addition to cover 106 and intermediate layer 102, a core 108 or golf ball subassembly 112. Along line 1A of FIG. 1A, the cross section of intermediate layer parting line 104 is above the cross section of cover parting line 114.

FIG. 3 illustrates a cross-sectional view of golf ball 100 of FIG. 1A across line 1B. This view is identical to FIG. 2 except that along line 1B of FIG. 1A, the cross section of intermediate layer parting line 104 is below the cross-section of cover parting line 114.

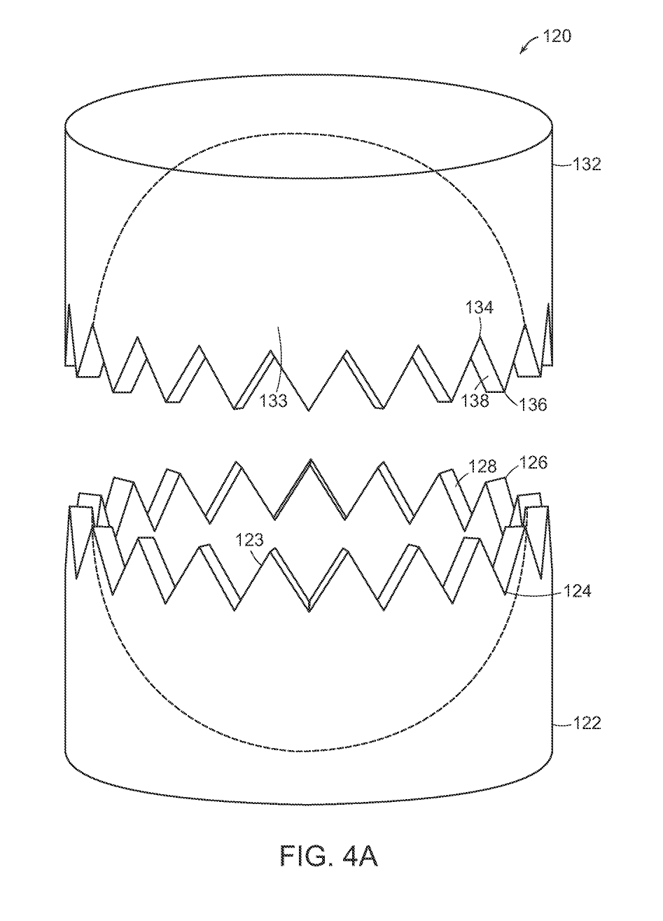

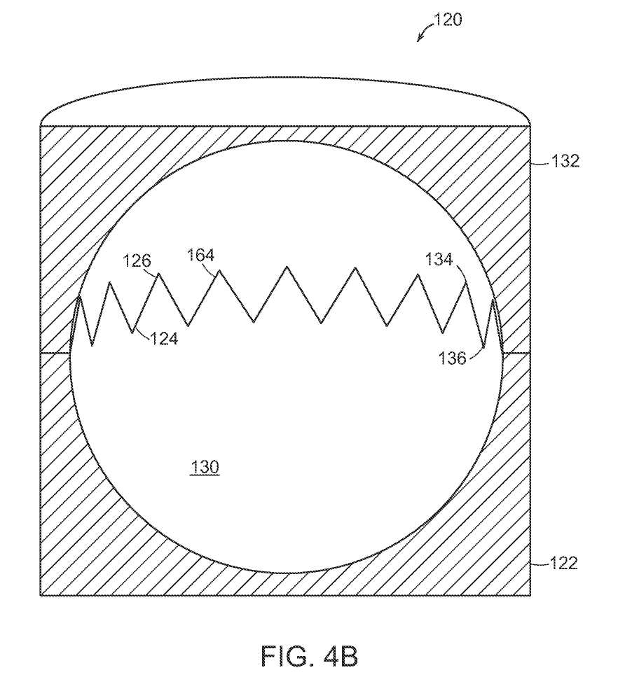

FIG. 4A illustrates a mold 120 for compression molding intermediate layer 102 of a golf ball 100 of the present invention. Mold 120 is comprised of half molds 122 and 132. Half molds 122 and 132 each have a mating surface, 128 and 138 respectively. Mating surfaces 128 and 138 comprises a plurality of indentations 124 and 134, respectively, and protrusions, 126 and 136, respectively. Each of half molds 122 and 132 define a substantially hemispherical cavity 123 and 133 respectively.

FIG. 4B illustrates a cross sectional view of mold 120 wherein half molds 122 and 132 are mated. When two half molds 122 and 132 are mated, protrusions 126 of first half mold 122 fill indentations 134 of second half mold 132, and protrusions 136 of second half mold 132 fill indentations 124 of first half mold 122, and substantially hemispherical cavities 123 and 133 together form spherical cavity 130. When half molds 122 and 132 are so mated, the interface between mating surfaces 128 and 138 of FIG. 4 defines a mold parting line 164 on the surface of spherical cavity 130.

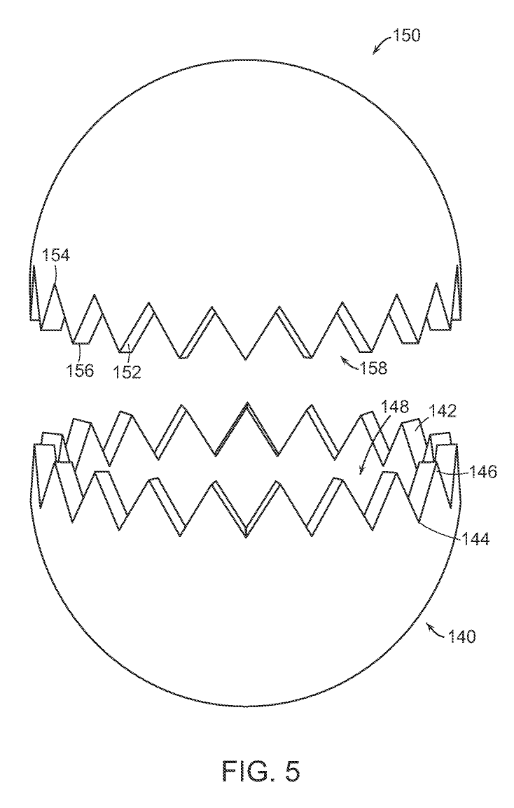

FIG. 5 illustrates two substantially hemispherical blanks 140 and 150 that would be used in a compression molding operation to form intermediate layer 102. Each hemispherical blank 140 or 150 comprises a mating surface 142 and 152 respectively, wherein each mating surface comprises a plurality of indentations 144 and 154, respectively, and protrusions, 146 and 156, respectively. Each blank 140 or 150 defines therein a substantially hemispherical cavity 148 or 158 respectively, sized and dimensioned partially cover a golf ball core 108 or subassembly 112. Protrusions 146 of first blank 140 are sized and dimensioned to fill indentations 154 of second blank 150, and protrusions 156 of second blank 150 are sized and dimensioned to fill indentations 144 of first blank 140.

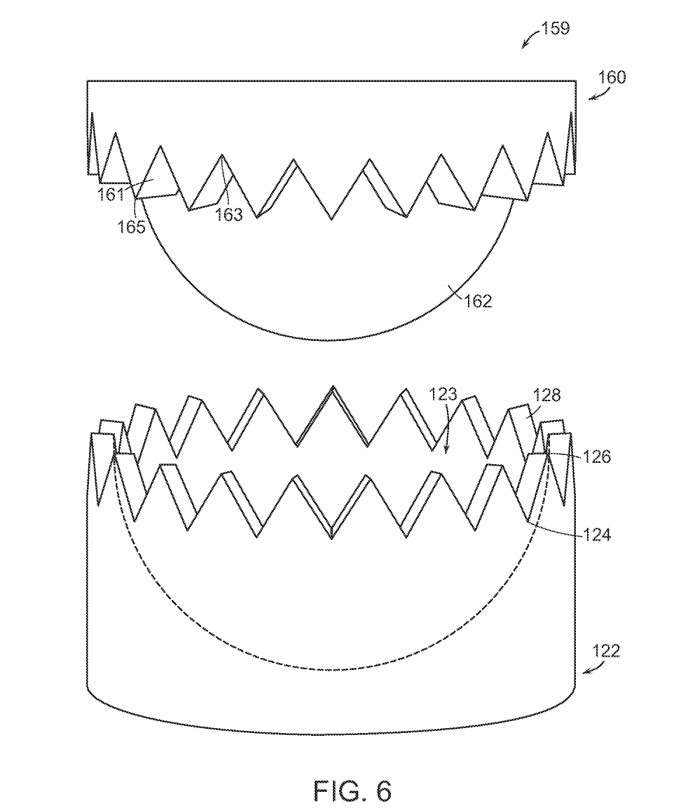

FIG. 6 illustrates an exemplary mold 159 for forming blank 140 or 150. Blank forming mold 159 comprises a half mold 122, as described with reference to FIG. 4 and a protrusive mold part 160. Protrusive mold part 160 comprises a substantially hemispherical protrusion 162 and a mating and molding surface 161 sized and dimensioned to mate with mating surface 128 of half mold 122 and to form mating surface 142 or 152 of blank 140 or 150 to be formed therein. This is accomplished by making the outer diameter of protrusive mold part 160 equal to that of half mold 122, but making the width of mating and molding surface 161 equal to the sum of the width of mating surface 128 of half mold 122 and mating surface 142 or 152 of blank 140 or 150 to be formed. Mating and molding surface 161 comprises a plurality of indentations 163 and protrusions 165, wherein protrusions 165 are sized and dimensioned such that they fill indentation 124 in half mold 122, and indentations 163 are sized and dimensioned such that protrusions 126 of half mold 122 fit into them. Protrusion 162 bounds and fills the area concentrically adjacent to mating and molding surface 161. When half mold 122 and protrusive mold part 160 are mated, protrusion 162 protrudes into substantially hemispherical mold cavity 123, and half mold 122 and protrusive mold part 160 define a blank cavity therebetween, bounded by the inner surface of substantially hemispherical cavity 123, a portion of mating and molding surface 161, and protrusion 162.

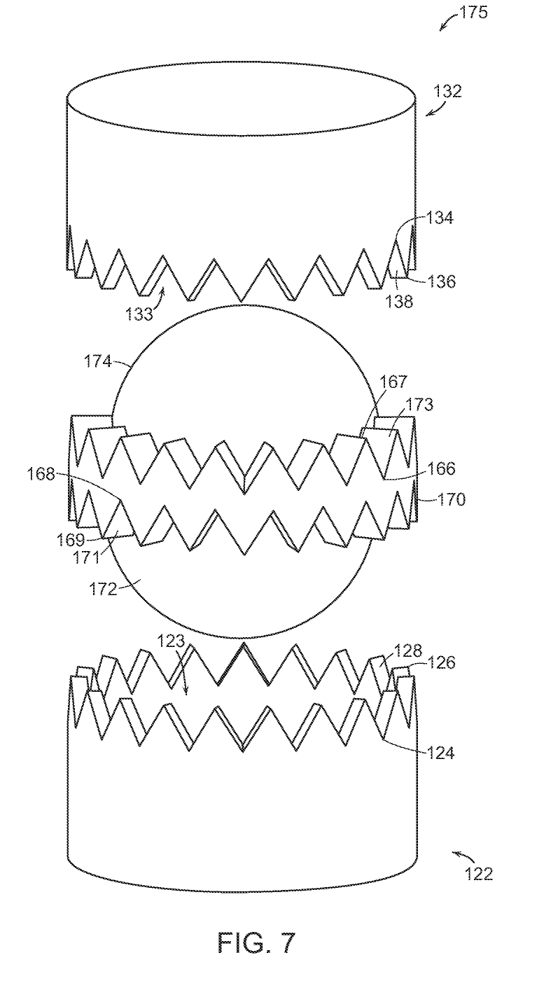

FIG. 7 illustrates an exemplary mold 175 for forming two blanks 140 and 150 concurrently. Blank forming mold 175 comprises two half molds 122 and 132, as described with reference to FIG. 4, and a protrusive mold part 170. Protrusive mold part 170 comprises two substantially hemispherical protrusions 172 and 174, and two mating and molding surfaces 171 and 173, similar to those described with respect to FIG. 6, and each have protrusions 167 and 169, respectively, and indentations 166 and 168, respectively, sized and dimensioned to mate with indentations 124 and 134 and protrusions 126 and 136 of first and second half molds 122 and 132 respectively in like manner to the arrangement described with respect to FIG. 6. When mating surfaces 128 and 138 on half molds 122 and 132, respectively, are mated with the respective mating and molding surfaces 171 and 173 on protrusive mold part 170, they define a pair of blank spaces between each of first half mold 122 and protrusive mold part 172 and between second half mold 132 and protrusive mold part 172, similar to the blank space defined with respect to FIG. 6

When forming blanks in molds of the style of either of blank molds 159 or 175, any of compression molding, injection molding or RIM may be used. Additionally, other manufacturing processes, such as casting, would be identifiable by one having skill in the art as being usable for forming blanks 140 and 150 described herein.

When forming blanks 140 and 150 within either of blank molds 159 or 175 using compression molding, a pre-sized piece of layer material is placed between in substantially hemispherical cavity 123 or 133 and protrusion 162, 172, or 174 of protrusive mold part 160 or 170. Mold 159 or 175 and blank material are heated, and half mold(s) 122 and/or 132 and protrusive mold part 160 or 170 are forced together to force the layer material to conform to the shape of the blank space, and thereby fill the blank space. The layer material is allowed to cool to form a blank 140 or 150, and at least protrusive mold part 160 or 170 is removed. Blank 140 or 150 may be removed from half mold 122 or 132, but it is preferred to leave blank 140 or 150 in half mold 122 or 132.

When forming blanks 140 and 150 within either of blank molds 159 or 175 using injection molding, blank molds 159 and 175 must be modified slightly to accommodate the differing requirements of the molding process. One or more gates to allow heated viscous layer material to be injected must be added to mold 159 or 175, preferably within half mold 122 or 132, more preferably at the center of half mold 122 or 132 Also, one or more vents must be added to mold 159 or 175, preferably near the mating surfaces of half mold 122 or 132 and protrusive mold part 160 or 170, more preferably at the interface between protrusions 126 or 136 of half mold 122 or 132 and indentations 163, 166, or 168 of protrusive mold part 160 or 170. Additionally, mold 159 or 175 may have ejector pins to remove completed blank 140 or 150 from one or both of half mold(s) 122 and/or 132 and protrusive mold part 160 or 170. To form blanks, half mold(s) 122 and/or 132 and protrusive mold part 160 or 170 are mated to form blank spaces. Heated viscous layer material is injected into the blank space through the gate. As the heated, viscous layer material fills the blank space, air and gases trapped within the blank space exit through the vents. Layer material is continually forced into the blank space until the blank space is substantially full of layer material. The layer material is allowed to cool and harden to form blank 140 or 150. The ejector pins may optionally be used to help to remove blank 140 or 150 from one or both of half mold 122 or 132 and protrusive mold part 160 or 170.

When forming blanks 140 and 150 within either of blank molds 159 or 175 using RIM, the molds used are similar to those used in injection molding except that they include a method of mixing two or more layer material precursors upstream of the gate(s). To form a blank 140 or 150 via RIM, mold 159 or 175 is mated as described above with respect to injection molding. Layer material precursors are mixed upstream of the gate, using devices such as peanut mixers and/or impingment mix heads, and forced through the gates into the blank space. When the layer material precursors are mixed, they begin to polymerize and cross-link, which increases the viscosity of the mixture, and it is therefore important to inject the precursor mixture into the blank space quickly. Once the blank space is full of polymerizing precursor mixture, and any air or gas trapped in the mold when the mold was closed has exited through the vents, the blanks are allowed to partially cure to form a semi-cure thermoset or a thermoplastic blank 140 or 150. At least the protrusive mold part 160 or 170 may then be removed, optionally with the use of ejector pins.

After blanks 140 and 150 have been formed, a golf ball subassembly 112 should be placed in between blanks 140 and 150 and half molds 122 and 132 should be closed about blanks 140 and 150. Mold 120 should then be run through a compression molding operation, wherein the half molds 122 and 132 are placed under high heat and pressure to cause the blank material to polymerize and cross-link between mating surfaces 128 and 138. This polymerization and cross-linking will cause blanks 140 and 150 to become a unified intermediate layer 102 about golf ball precursor 112. Because blanks 140 and 150 had non-planar mating surfaces 142 and 152, and mold 120 has a non-planar parting line 164, intermediate layer 102 will have a non-planar parting line 104 thereon. Because parting line 104 of intermediate layer 102 is non-planar, it is longer than would be a planar parting line. This increased length ensures increased bond strength between blanks 140 and 150 that form intermediate layer 102. Additionally, the non-planar shape of parting line 104 of intermediate layer 102 causes increased mixing along mating surfaces 128 and 138 during the high pressure cure portion of the compression molding process. This increased mixing also causes the bond between blanks 140 and 150 to be stronger than it would be in the case of an intermediate layer having a planar parting line. Third, the non-planar shape of the mold causes interruption in the flow of excess material exiting the mold. If the flow of the excess material is not interrupted, the flow may linearize and cause the polymers in the layer material to align. This alignment of polymers may cause the bonding between neighboring polymers to be weaker than if the polymers were misaligned. This weakened bonding between layers could extend around the parting line of the layer and cause an area of relative weakness in the polymer layer. By interrupting the flow of the excess layer material as it exits the mold along the parting line, the linearization of excess layer material may be minimized, increasing the strength of the bonding between adjacent polymers, and thereby increasing the strength of the bonding around the parting line area as compared to layers made with a conventional construction. Also, interrupting the flow of excess material may cause increased turbulence and mixing at the parting line, further strengthening the resultant bond between blanks 140 and 150. Once the polymerization process is substantially complete, mold 120 and golf ball subassembly 112 with intermediate layer 102 can be cooled, and golf ball subassembly 112 with intermediate layer 102 can be demolded for further processing or layer addition.

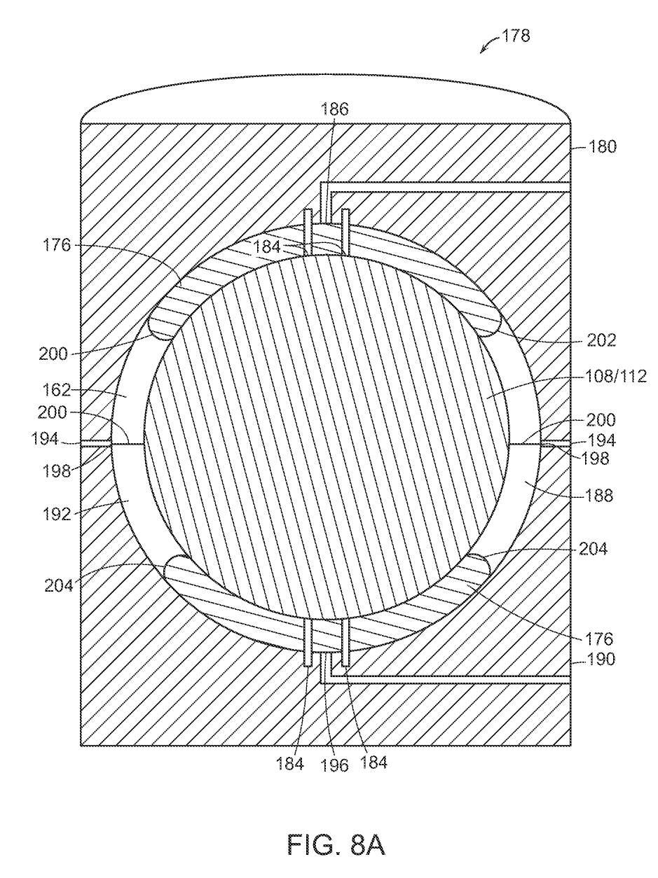

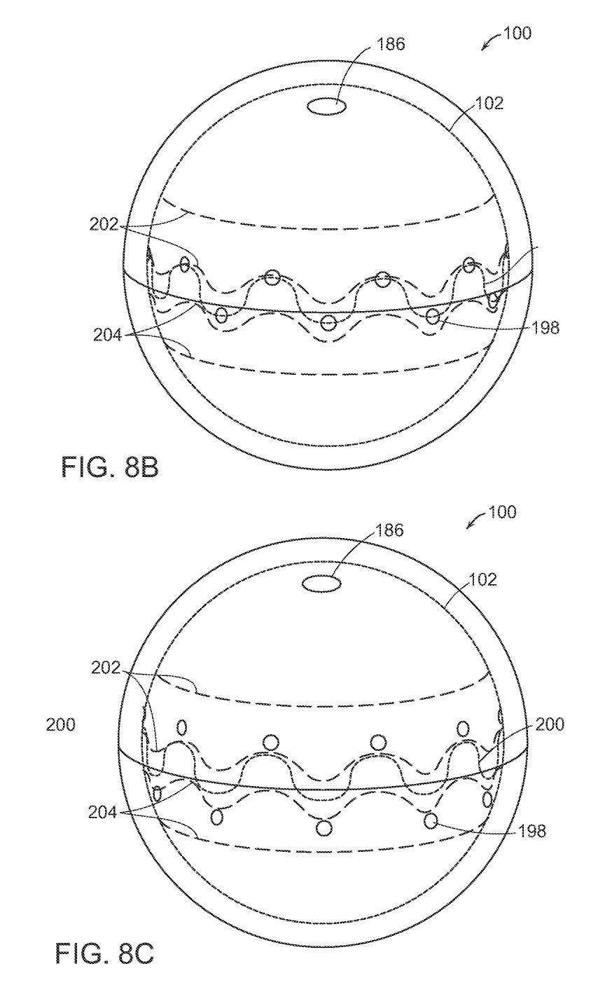

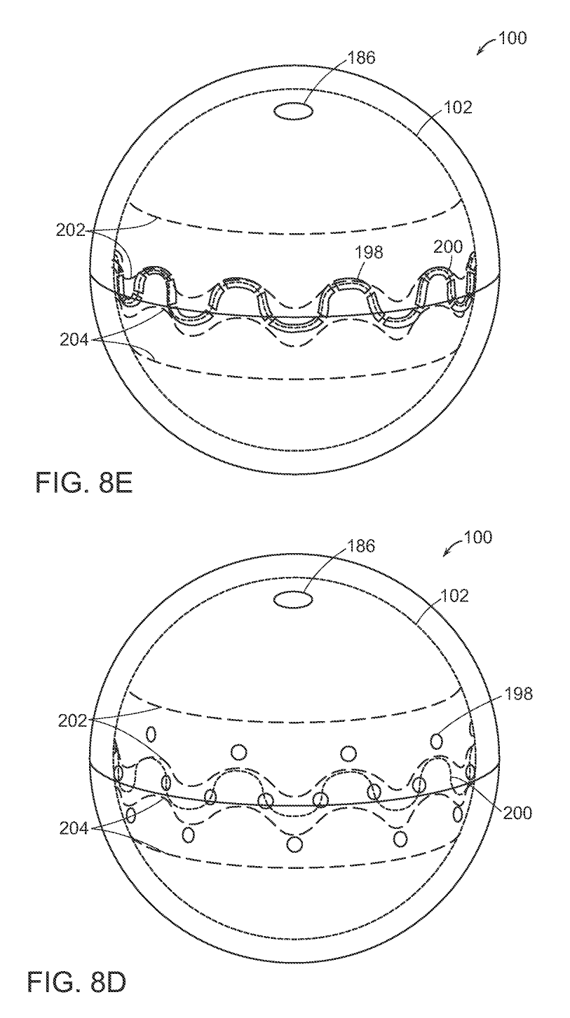

When golf ball layers are fabricated using an injection molding process, an injection molding assembly 178, as seen in FIG. 8A, may be used. Injection molding assembly 178 is shaped similarly to mold 120 illustrated in FIGS. 4A and 4B. Injection molding assembly 178 comprises a pair of substantially hemispherical mold halves 180 and 190. Mold halves 180 and 190 are shaped substantially like half molds 122 and 132, and comprise similar non-planar mating surfaces having interlocking indentations and protrusions, which form a non-planar parting line 198 on the surface of spherical mold cavity 178.

During an injection molding process, retractable pins 184 in first mold half 180 are extended and golf ball subassembly 112 is placed upon pins 184. Second mold half 190 is sealed to first mold half 180 and retractable pins 184 in second mold half 190 are extended to secure golf ball subassembly 112 within spherical cavity 188 defined by substantially hemispherical cavities 182 and 192 in mold halves 180 and 190, respectively. Heated, viscous layer material 176 is injected through gates 186 and 196 of mold halves 180 and 190, respectively. Air and gases trapped in spherical cavity 188 when mold halves 180 and 190 were sealed escapes through vents 198 disposed along parting line 194 as shown in FIG. 8A. Once golf ball subassembly 112 is fully supported and stabilized by layer material 176, retractable pins 184 retract, and layer material 166 fills the space vacated by pins 184. As layer material 176 moves outward from gates 186 and 196, it may form flow fronts 202 and 204, respectively, as it is forced around golf ball subassembly 112. Eventually, flow fronts 202 and 204 will intersect, generally in the area of mold parting line 194 due to the presence of vents 198, which provides paths of least resistance, to form a knit line 200.

FIGS. 8B-E illustrate exemplary formations of a non-planar knit line using an injection molding system having a series of offset vents. In injection molding systems, molten material generally takes the path of least resistance to areas of lower pressure. As a result, molten material migrates preferentially toward the low pressure areas around vents. Adjusting the position of vents in an injection mold therefore allows a manufacturer to regulate the movement of molten material within the injection mold. In FIG. 8B, vents 198 can be positioned at the peaks and troughs of knit line 200. In this embodiment, when the molten material reaches a peak it no longer migrates toward the equator of layer 102; however, the molten material can continue to migrate toward the equator between the peaks until it reaches a trough to form the wavy parting line. Alternatively, vents can be positioned above and below the peaks and troughs of knit line 200 as illustrated in FIG. 8C. In this embodiment, the molten material may flow beyond the vents located proximate to the peaks, but at a slower rate than the molten material between the vents proximate to the peaks since some of the molten material may exit through the vents. This difference in flow rates creates a non-planar parting line. Whether a particular molding operation will form layer 102 as shown in FIGS. 8B or that as shown in FIG. 8C depends on several factors, including the thickness of the layer being formed, the density, viscosity, and melt flow index of the layer material, the size of the vents, and the rate at which layer material is forced into the mold. The melt flow index of the layer material is preferably between 1.0 and 4.0 grams polymer/10 minute flow time, more preferably between 1.3 and 1.6 grams polymer/10 minute flow time, and most preferably is 1.45 grams polymer per 10 minute flow time. In each case, because vents 198 are arranged in a non-planar fashion along mold parting line 194, knit line 200 will approximate the non-planar shape of mold parting line 198. FIG. 8D illustrates another vent arrangement, which is similar to the arrangement in FIG. 8C, but includes additional vents along the equator of the intermediate layer, to improve the ability of trapped gases to escape the mold. A system of elongated vents along mold parting line 198, shown in FIG. 8E, can provide a more definite barrier to layer material overflow, and can be used to improve consistency in the shape of non-planar knit line 200.

Intermediate layer 102 having non planar knit line 200 will exhibit increased strength and durability as compared to a traditionally produced layer having a planar knit line, because of increased strength of the bond between layer material 166 from different injection gates 186 and 196 along knit line 200. A non-planar knit line increases the length of the knit line, so there is greater total knit area between the two sections of layer material, which increases the overall strength of the bond between the upper and lower sections of layer material 176. Additionally, the non-planar arrangement of vents 198 will cause an interruption in the flow of excess layer material out of the mold which results in increased mixing, similar to the situation discussed above with respect to compression molded blanks having a non-planar parting line, including increased turbulence and mixing along the knit line and decreased linearization along the knit line, leading to a stronger bond between adjacent fronts 202 and 204 of layer material 176.

When layer material 176 injected via gates 186 and 196 completely fills spherical cavity 188 and meets at parting line 194 to form knit line 200, and substantially all air and gases trapped in spherical cavity 188 have escaped through vents 198, mold 178 is allowed to cool, and layer material 176 solidifies. Mold halves 180 and 190 are separated and golf ball subassembly 112 encased in layer 102 formed of layer material 176 is removed from mold 178. Golf ball subassembly 112 and layer 102 may now be subjected to further processing, or have cover 106 or other outer layers formed around layer 102 as seen in FIG. 2.

In an alternative embodiment, the injection mold comprises a plurality of “deep dimples” which hold the golf ball subassembly in place in place of the retractable pins. These deep dimples are dimples that will be present on the finished ball that extend through the cover and the intermediate layer, such that they may support the subassembly during the molding process. A more complete discussion of “deep dimples” is given in U.S. Pat. No. 7,070,726 which is incorporated herein by reference.

When golf ball layers are fabricated via a reaction injection molding process as contemplated by the present invention, the process is similar to that described with respect to injection molding described above. The main difference is that, while injection molding injects viscous heated thermoplastic layer material into the mold cavity under high heat and pressure where it cools to form a layer, RIM mixes highly reactive thermoset precursors and injects them into the mold cavity, wherein the precursors react to form an integral thermoset. In practice, the precursors are injected are either mixed using an in-line mixer, such as a peanut mixer, or are injected into the mold cavity using an impingement mix head. One of the precursors often includes a catalyst to speed the reaction. Once the precursors are mixed, they will begin to react immediately to produce a thermoset, so it is critical that the precursor mixture is injected quickly into the molding chamber. After the layer material is injected into the mold cavity, it will continue to react, or cure, to produce the final layer material. Much as in the case with standard injection molding, layer material from opposing gates will meet along a knit line which will approximate the mold parting line due to the non-planar arrangement of vents along the mold parting line. Because the mold parting line is non-planar, there will be decreased linearization and greater turbulence and mixing of the precursor material as excess layer material exits the mold, which will create a stronger bond along the knit line.

Test Data

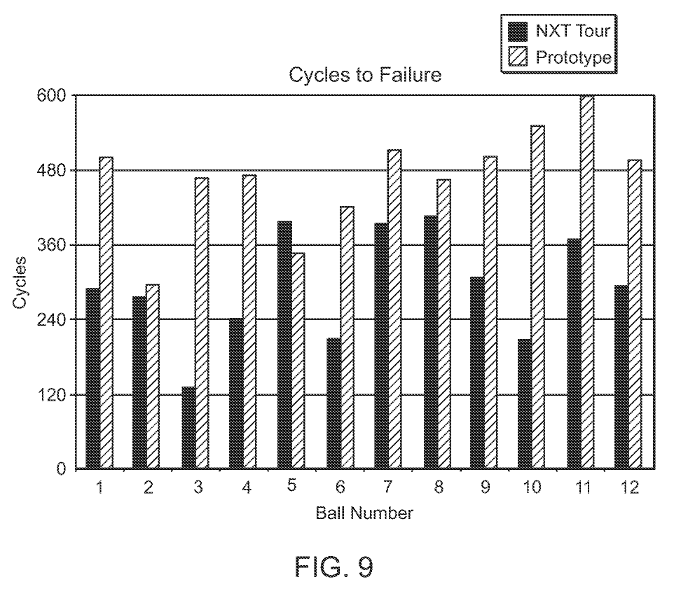

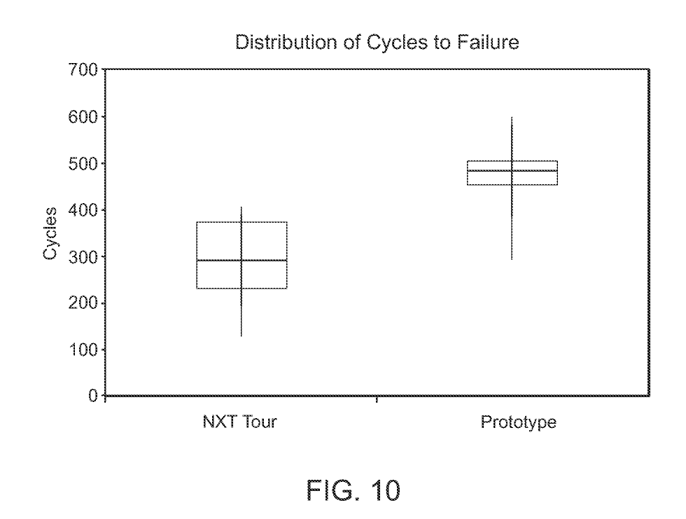

When produced according to the present invention, golf balls having an intermediate layer withstood on average 60 percent more impacts than comparable balls made with a planar parting line on the intermediate layer, with no significant change in Coefficient of Restitution (CoR) or initial velocity. Specifically, 12 Titleist NXT Tour golf balls as controls were compared with 12 prototype balls formed to the same materials, the only difference being the prototype golf balls were formed having a compression molded inner cover layer with a non-planar parting line having a shape similar to the parting line depicted in FIG. 1C. Each ball was fired repeatedly out of an air cannon with a targeted initial velocity of 155 feet per second. The initial velocity and CoR were measured for each ball on each strike. Balls were fired repeatedly until failure. The number of cycles until failure for each ball and the box-whisker plot of the distributions are illustrated in FIGS. 9 and 10, respectively. Of the 12 control balls, the first failed after 130 firings, a quarter had failed by 208 firings, half had failed after 292 firings, three quarters had failed by 367 firings, and all had failed by 406 firings. Of the 12 prototype balls, the first failed after 295 firings, a quarter had failed after 421 firings, half had failed after 471 firings, three quarters had failed by 502 firings., and all had failed by 598 firings. The average number of firings to failure for the control balls was 292.5 firings, with a standard deviation of 87.1 firings. The average number of firings to failure for the prototype balls was 468.5 firings, with a standard deviation of 83.2 firings. There was no significant difference in velocity or coefficient of restitution between the control balls and the prototype balls.

Core Compositions and Construction

A golf ball core for use in the present invention may be formed in any way known in the art, and may include polybutadiene, a metal salt diacrylate or dimethacrylate, preferably, zinc diacrylate, and a free radical initiator, to which calcium oxide (CaO) or zinc oxide can be added as an activation agent in an amount sufficient to produce a golf ball core layer with the advantageous properties discussed below. An extensive discussion of compositions and dimensions for core layers, intermediate layers and cover layers can be found in the known art including but not limited to U.S. Pat. Nos. 6,517,451, 6,152,834, 5,919,100, 5,885,172, 5,783,293, 5,692,974, 7,358,309, 6,815,480 and PCT Publication No. WO 00/29129, all of which are hereby incorporated by reference in their entireties.

A representative base composition for forming a golf ball core layer for use in the present invention comprises polybutadiene and, in parts by weight based on 100 parts polybutadiene, 20 to 50 parts of a metal salt diacrylate, dimethacrylate, or monomethacrylate, preferably zinc diacrylate. The polybutadiene preferably has a cis-1,4 content of at least 40%, preferably above about 90% and more preferably above about 96%. Commercial sources of polybutadiene include Shell 1220 manufactured by Shell Chemical, Neocis BR40 and BR60 manufactured by Enichem Elastomers, Ubepol BRI 50 and 360 manufactured by Ube Industries, Ltd., CB23 manufactured by Bayer AG, and BUDENE 1207G manufactured by Goodyear. In one preferred embodiment, a golf ball core layer may include one or more of BR60, 360, CB23, and BUDENE 1207G because of the higher resilience index of these materials. If desired, the polybutadiene can also be mixed with other elastomers known in the art, such as natural rubber, styrene butadiene, and/or isoprene in order to further modify the properties of the core layer. When a mixture of elastomers is used, the amounts of other constituents in the core composition are generally based on 100 parts by weight of the total elastomer mixture.

Metal salt diacrylates, dimethacrylates, and monomethacrylates suitable for use in cores which may be used with this invention include those wherein the metal is magnesium, calcium, zinc, aluminum, sodium, lithium or nickel. Zinc diacrylate is preferred, because it provides golf balls with a high initial velocity. The zinc diacrylate can be of various grades of purity. Zinc diacrylate containing about 1-10% zinc stearate is preferable. More preferable is zinc diacrylate containing about 4-8% zinc stearate. Suitable, commercially available zinc diacrylates include those from Rockland React-Rite and Sartomer. The preferred concentrations of zinc diacrylate that can be used are 20-50 pph based upon 100 parts of polybutadiene or, alternately, polybutadiene with a mixture of other elastomers.

Free radical initiators are used to promote crosslinking of the metal salt diacrylate, dimethacrylate, or monomethacrylate and the polybutadiene. Suitable free radical initiators for use in the invention include, but are not limited to peroxide compounds, such as dicumylperoxide, 1,1-di(t-butylperoxy)-3,3,5-trimethylcyclohexane, α,α-bis(t-butylperoxy) diisopropylbenzene, 2,5-dimethyl-2,5-di(t-butylperoxy)hexane, or di-t-butylperoxide, and mixtures thereof. Other useful initiators would be readily apparent to one of ordinary skill in the art without any need for experimentation. The initiator(s) at 100% activity are preferably added in an amount ranging between about 0.05 and 2.5 pph based upon 100 parts of butadiene, or butadiene mixed with one or more other elastomers. More preferably, the amount of initiator added ranges between about 0.15 and 2 pph and most preferably between about 0.25 and 1.5 pph.

Typically, a golf ball core layer incorporates 5 to 50 pph of zinc oxide in a zinc diacrylate-peroxide cure system that cross-links polybutadiene during the core molding process. The high specific gravity of zinc oxide, about 5.57, permits the adjustment of the specific gravity of the core layer and resulting golf ball incorporating the core layer. The elimination or at least the reduction of environmentally unfriendly zinc oxide from the manufacturing process is desirable in certain circumstances. In the case of golf ball core formulations, however, completely eliminating zinc oxide results in a significant reduction in cure enhancement, so that there is a reduction in the cross-linking of the polybutadiene with a resultant decrease in both compression and initial velocity. Although the core layer and resulting ball have a softer feel, driving distance suffers as a result of the significantly lower initial velocity. When zinc oxide (ZnO) is eliminated in favor of calcium oxide (CaO) in a golf ball core composition of polybutadiene and a metal salt diacrylate, dimethacrylate, or monomethacrylate, the cores and balls produced from such an admixture typically exhibit enhanced performance properties. The initial velocity of the standard ball is maintained at or near the maximum allowed by the United States Golf Association (USGA), but the compression of the ball is reduced by at least about 2 compression points on the Atti scale, and may be reduced as much as 14 points. Where the amount of zinc oxide incorporated in cores is, as noted above, typically about 5 to 50 pph, the amount of calcium oxide added to the core-forming composition of the invention as an activator is typically in the range of about 0.1 to 15, preferably 1 to 10, most preferably 1.25 to 5, parts calcium oxide per hundred parts (pph) of polybutadiene.

The compositions which may be used in the golf ball of the present invention may also include fillers, added to the elastomeric composition to adjust the density and/or specific gravity of the core. As used herein, the term “fillers” includes any compound or composition that can be used to vary the density and other properties of the subject golf ball core. Fillers useful in the golf ball core according to the present invention include, for example, zinc oxide (in an amount significantly less than that which would be necessary without the addition of the calcium oxide), barium sulfate, and regrind (which is recycled core molding matrix ground to 30 mesh particle size). The amount and type of filler utilized is governed by the amount and weight of other ingredients in the composition, since a maximum golf ball weight of 1.620 ounces (45.92 gm) has been established by the USGA. Appropriate fillers generally used range in specific gravity from about 2.0 to 5.6. In another embodiment, the specific gravity can be from about 2 to 20.

The golf ball cores which may be used in the present invention can be of any specific gravity which can be used in a golf ball. The preferred range of specific gravities of the present invention is from about 0.9 to about 1.5 or more, more preferably in the range of about 1 to about 1.25, depending upon the size of the core, cover, and finished ball, as well as the specific gravity of the cover. For example, the core specific gravity will be lower if the cover includes a filler to increase the specific gravity of the cover.

Antioxidants may also be included in the elastomer cores produced for use in the present invention. Antioxidants are compounds which prevent the breakdown of the elastomer. Antioxidants useful in the present invention include, but are not limited to, quinoline type antioxidants, amine type antioxidants, and phenolic type antioxidants.

Other ingredients such as accelerators, e.g., tetramethylthiuram, processing aids, processing oils, plasticizers, dyes and pigments, as well as other additives well known to the skilled artisan may also be used in cores for use in the present invention in amounts sufficient to achieve the purpose for which they are typically used.

The core compositions used in golf balls of the present invention may be produced by forming a mixture comprising at least polybutadiene, zinc diacrylate, and an amount of calcium oxide sufficient, when desired, to reduce the compression by at least about 2 compression points on the Atti scale, compared to a core composition substituting zinc oxide for the calcium oxide, optionally with one or more additional components, such as additives. When a set of predetermined conditions is met, i.e., time and temperature of mixing, the free radical initiator is added in an amount dependent upon the amounts and relative ratios of the starting components, as would be well understood by one of ordinary skill in the art. In particular, as the components are mixed, the resultant shear causes the temperature of the mixture to rise. Peroxide(s) free radical initiator(s) are blended into the mixture for crosslinking purposes in the molding process.

After completion of the mixing, the golf ball core composition is milled and hand prepped or extruded into pieces (“preps”) suitable for molding. The preps are then compression molded into cores at an elevated temperature. Typically, 160° C. (320° F.) for 15 minutes is suitable for this purpose. A person having skill in the art would understand that this is just one of many suitable golf ball cores, methods of producing cores, and core compositions.

Golf ball cores for use in the present invention may also be fluid cores. When a fluid core is used, the fluid core can be encased in a fluid center shell, or can alternatively be encased directly in an intermediate layer formed either through the use of pre-formed mold halves which are compression fused prior to being filled with the fluid core material or by solidifying the fluid core, and molding the intermediate layer about the core before the core melts. Such a core may be made of any fluid known in the art to be usable for making a golf ball core, including, but not limited to solutions such as air, water, glycerine, paste, foams, oils, water solutions such as salt in water, corn syrup, salt in water and corn syrup, or glycol and water. The fluid can also include pastes, colloidal suspensions, such as clay, barites, carbon black in water or other liquid, or salt in water/glycol mixtures; gels, such as gelatin gels, hydrogels, water/methyl cellulose gels and gels comprised of copolymer rubber based materials such as styrene-butadiene-styrene rubber and paraffinic and/or napthenic oil; or melts including waxes and hot melts. Hot melts are materials at which or about normal room temperature are solid but at elevated temperatures become liquid. These fluid cores can also be reactive liquid systems which combine to form a solid. Examples of such reactive liquids are silicate gels, agar gels, and peroxide cured liquid polybutadiene rubber compositions. It is understood that one of skill in the art that other reactive liquid systems can likewise be utilized depending on the physical properties of the fluid center shell or encasing intermediate layer and the physical properties desired in the resulting finished balls. A more complete discussion of fluid cored golf balls is included in U.S. Pat. No. 6,797,097, which is hereby incorporated by reference in its entirety.

Intermediate Layer Composition and Construction

Golf ball intermediate layers 102 as produced by the present invention may be made using any composition known in the art compatible with an acceptable molding process, such as using semi-cure thermosets or thermoplastics to make mold blanks for use in compression molding, using thermoplastics for injection molding or retractable pin injection molding, or using reactive liquid mixtures that react to form thermosets or thermoplastics for RIM. Several types of components that could be used with acceptable molding processes include all thermoplastic and thermoset materials, including high acid ionomers, blends of ionomers, multiple cation ionomers, ionomeric, non-ionomeric, urethane, urea, metallocene and blends of all of the aforementioned and thermoset materials such as heavily cross-linked polyurethanes or polyureas, balata, or cross-linkable silane plastics, as well as many others that would be readily identifiable by one having skill in the art.

The thermoplastic intermediate layers made by compression or injection molding may also likewise include one or more homopolymeric or copolymeric materials, such as vinyl resins, polyolefins, polyurethanes, and polyureas, such as the ones disclosed in U.S. Pat. Nos. 5,334,673 and 5,484,870, polyamides, acrylic resins, polyphenylene oxide resins, thermoplastic polyester, its blends and alloys, and/or blends of thermoplastic rubbers.

These intermediate layers may also include, thermoplastic polymers, such as ethylene, propylene, butene-1 or hexane-1 based homopolymers or copolymers including functional monomers, such as acrylic and methacrylic acid and fully or partially neutralized ionomer resins and their blends, methyl acrylate, methyl methacrylate, homopolymers and copolymers, imidized, amino group containing polymers, polycarbonate, reinforced polyamides, polyphenylene oxide, high impact polystyrene, polyether ketone, polysulfone, poly(phenylene sulfide), acrylonitrile-butadiene, acrylic-styrene-acrylonitrile, poly(ethylene terephthalate), poly(butylene terephthalate), poly(ethylene vinyl alcohol), poly(tetrafluoroethylene) and their copolymers including functional comonomers, and blends thereof.

These intermediate layers may also include ionomeric materials, such as ionic copolymers of ethylene and an unsaturated monocarboxylic acid, which are available under the trademark SURLYN® of E. I. DuPont Nemours & Co., of Wilmington, Del., or IOTEK® or ESCOR® of Exxon.

These intermediate layer may also include at least one ionomer, such as acid-containing ethylene copolymer ionomers, including E/X/Y terpolymers where E is ethylene, X is an acrylate or methacrylate-based softening comonomer, and Y is acrylic or methacrylic acid. The ionomer may also include so-called “low acid” and “high acid” ionomers, as well as blends thereof, such as those discussed in U.S. Pat. Nos. 6,960,629 and 6,998,444, the entireties of which are incorporated herein by reference. In general, ionic copolymers including up to 15 percent acid are considered “low acid” ionomers, while those including greater than about 15 percent acid are considered “high acid” ionomers.

These intermediate layers may also be formed from at least one polymer containing α,β-unsaturated carboxylic acid groups, or the salts thereof, that have been 100 percent neutralized by organic fatty acids, such as those disclosed in U.S. Pat. Nos. 6,960,629 and 6,998,444.

These intermediate layers may also include highly neutralized polymers, such as those disclosed in U.S. Patent Nos. 6,565,455 and 6,565,456, the entireties of which are incorporated by reference herein; and/or grafted and non-grafted metallocene catalyzed polyolefins and polyamides, polyamide/ionomer blends, and polyamide/nonionomer blends, such as those disclosed in U.S. Pat. No. 6,800,690, which is incorporated by reference herein in its entirety; among other polymers. Examples of other suitable intermediate layer materials include blends of some of the above materials, such as those disclosed in U.S. Pat. No. 5,688,191, the entire disclosure of which is incorporated by reference herein, as well as the other materials disclosed therein.

Polyurethane and/or polyurea polymers produced via RIM systems are typically made from three reactants: alcohols, amines, and isocyanate-containing compounds. Both alcohols and amines have a reactive hydrogen atom and are generally referred to as “polyols”. They react with the isocyanate-containing compound, which is generally referred to as an “isocyanate.”

Several chemical reactions may occur during polymerization of isocyanate and polyol. Isocyanate groups (—N═C═O) that react with alcohols form a polyurethane, whereas isocyanate groups that react with an amine group form a polyurea. A polyurethane itself may react with an isocyanate to form an allophanate and a polyurea can react with an isocyanate to form a biuret. Because the biuret and allophanate reactions occur on an already-substituted nitrogen atom of the polyurethane or polyurea, these reactions increase cross-linking within the polymer.

Polyurethanes/polyureas are generally formed by mixing two primary ingredients during processing. For the most commonly used polyurethanes, the two primary ingredients are a polyisocyanate (for example, diphenylmethane diisocyanate monomer (MDI) and toluene diisocyanate (TDI) and their derivatives) and a polyol (for example, a polyester polyol or a polyether polyol).

A wide range of combinations of polyisocyanates and polyols, as well as other ingredients, are available. Furthermore, the end-use properties of polyurethanes can be controlled by the type of polyurethane utilized, i.e., whether the material is thermoset (cross linked molecular structure) or thermoplastic (linear molecular structure).

The polyol component typically contains additives, such as stabilizers, flow modifiers, catalysts, combustion modifiers, blowing agents, fillers, pigments, optical brighteners, and release agents to modify physical characteristics of the cover. Furthermore, the polyol component may contain surfactants or other additives which promote better mixing of the two components. Polyurethane/polyurea constituent molecules that were derived from recycled polyurethane can be added in the polyol component.

Cross linking occurs between the isocyanate groups (—NCO) and the polyol's hydroxyl end-groups (—OH). Additionally, the end-use characteristics of polyurethanes can also be controlled by different types of reactive chemicals and processing parameters. For example, catalysts are utilized to control polymerization rates. Depending upon the processing method, reaction rates can be very quick.

Polyurethanes/polyureas produced by RIM can be thermosetting or thermoplastic. A polyurethane becomes irreversibly set when a polyurethane prepolymer is cross-linked with a polyfunctional curing agent, such as a polyamine or a polyol. The prepolymer typically is made from polyether or polyester. Diisocyanate polyethers are preferred because of their water resistance.

The physical properties of thermoset polyurethanes are controlled substantially by the degree of cross linking. Tightly cross linked polyurethanes/polyureas are fairly rigid and strong. A lower amount of cross linking results in materials that are flexible and resilient. Thermoplastic polyurethanes have some cross linking, but primarily by physical means. The crosslinkings bonds can be reversibly broken by increasing temperature, as occurs during molding or extrusion. They can be used up to about 350° F. and are available in a wide range of hardnesses.

Polyurethane materials suitable for the exemplary embodiments are formed by the reaction of a polyisocyanate, a polyol, and optionally one or more chain extenders. The polyol component includes any suitable polyether- or polyesterpolyol. Additionally, in an alternative embodiment, the polyol component comprises polybutadiene diol. The chain extenders include, but are not limited, to diols, triols and amine extenders. Any suitable polyisocyanate may be used to form a polyurethane according to the exemplary embodiment. The polyisocyanate is preferably selected from the group of diisocyanates including, but not limited, to 4,4N-diphenylmethane diisocyanate (“MDI”); 2,4-toluene diisocyanate (“TDI”); m-xylylene diisocyanate (“XDI”); methylene bis-(4-cyclohexyl isocyanate) (“HMDI”); hexamethylene diisocyanate (HDI); naphthalene-1,5,-diisocyanate (“NDI”); 3,3N-dimethyl-4,4N-biphenyl diisocyanate (“TODI”); 1,4-diisocyanate benzene (“PPDI”); phenylene-1,4-diisocyanate; and 2,2,4-or 2,4,4-trimethyl hexamethylene diisocyanate (“TMDI”).

Other less preferred diisocyanates include, but are not limited to, isophorone diisocyanate (“IPDI”); 1,4-cyclohexyl diisocyanate (“CHDI”); diphenylether-4,4N-diisocyanate; p,pN-diphenyl diisocyanate; lysine diisocyanate (“LDI”); 1,3-bis (isocyanato methyl) cyclohexane; and polymethylene polyphenyl isocyanate (“PMDI”).

One polyurethane component which can be used in the exemplary embodiment incorporates TMXDI (META) aliphatic isocyanate (Cytec Industries, West Paterson, N.J.). Polyurethanes based on meta-tetramethylxylyliene diisocyanate can provide improved gloss retention, UV light stability, thermal stability and hydrolytic stability. Additionally, TMXDI (META) aliphatic isocyanate has demonstrated favorable toxicological properties. Furthermore, because it has a low viscosity, it is usable with a wider range of diols (to polyurethane) and diamines (to polyureas). If TMXDI is used, it typically, but not necessarily, is added as a direct replacement for some or all of the other aliphatic isocyanates in accordance with the suggestions of the supplier. Because of slow reactivity of TMXDI, it may be useful or necessary to use catalysts to have practical demolding times. Hardness, tensile strength and elongation can be adjusted by adding further materials in accordance with the supplier's instructions.

Suitable glycol chain extenders include, but are not limited to ethylene glycol; propane glycol; butane glycol; pentane glycol; hexane glycol; benzene glycol; xylenene glycol; 1,4-butane diol; 1,3-butane diol; 2,3-dimethyl-2,3-butane diol; and dipropylene glycol.

Suitable amine extenders include, but are not limited to, tetramethyl-ethylenediamine; dimethylbenzylamine; diethylbenzylamine; diethyltoluenediamine; pentamethyl diethylenetriamine; dimethyl cyclohexylamine; tetramethyl-1,3-butanediamine; 1,2-dimethylimidazole; 2-methylimidazole; pentamethyldipropylenetriamine; and bis-(dismethylaminoethylether).

The polyol component typically contains additives, such as stabilizers, flow modifiers, catalysts, combustion modifiers, blowing agents, fillers, pigments, optical brighteners, and release agents to modify physical characteristics of the intermediate layer.

Non-limiting examples of suitable RIM systems for use in the exemplary embodiment are VIBRARIM polyurethane/polyurea systems from Crompton Corporation (Middlebury, Conn.) and the Bayflex7 elastomeric polyurethane RIM systems, Baydur7 GS solid polyurethane RIM systems, Prism7 solid polyurethane RIM systems, all from Bayer Corp. (Pittsburgh, Pa.), SPECTRIM reaction moldable polyurethane and polyurea systems from Dow Chemical USA (Midland, Mich.), including SPECTRIM MM 373-A (isocyanate) and 373-B (polyol), and Elastolit SR systems from BASF (Parsippany, N.J.). Several systems available from Bayer include Bayflex 110-50 and Bayflex MP-10,000. BAYFLEX MP-10,000 is a two component system, consisting of Component A and Component B. Component A comprises the diisocyanate and Component B comprises the polyether polyol plus additional curatives, extenders, etc. Another suitable polyurethane/polyurea RIM system suitable for use with the exemplary embodiment is the VibraRIM system. VibraRIM 813A (Iso) and 813B (Polyol) are available from Crompton Chemical, now Chemtura of Middlebury, Conn. A sample plaque formed from the VibraRIM 813A and 813B components exhibited the following representative properties:

(1) Plaque material Shore D (peak)=39
(2) Specific gravity 1.098 g/cc
(3) Flexural mod. (ASTM D 790)=7920 psi.
(4) 300% mod. (ASTM D 412)=2650 psi.
(5) Young's mod. at 23 C (DMA)=75.5 MPa
(6) Shear mod. at 23C (DMA)=11.6 MPa

Golf balls of the present invention may also have additional intermediate layers. Such other intermediate layers may be made in any way known in the art of making intermediate layers, and may include any of the materials listed above for use in making the intermediate layers already described. These additional intermediate layers may be of a solid construction, or may be made of a wound construction formed of a tensioned elastomeric material. Such tensioned elastomeric materials can be wound to produce a hoop stress layer, such as those described in U.S. Pat. Nos. 6,695,717 and 6,893,361, the entire disclosures of which are incorporated herein by reference.

Intermediate Layers may also be formed of a binding material and an interstitial material distributed in the binding material, wherein the effective material properties of the intermediate layer are uniquely different for applied forces normal to the surface of the ball from applied forces tangential to the surface of the ball. Examples of this type of intermediate layer are disclosed in U.S. Pat. No. 6,629,898, the entire disclosure of which is hereby incorporated herein.

At least one intermediate layer may also be a moisture barrier layer, such as the ones described in U.S. Pat. No. 5,820,488, which is incorporated by reference herein. Any suitable film-forming material having a lower water vapor transmission rate that the other layers between the core and the outer surface of the ball may be used. Examples include, but are not limited to polyvinylchloride, vermiculite, and a reaction product with fluorine gas. Additional materials may be included in the intermediate layer compositions outlined above. For example, catalysts, coloring agents, optical brighteners, crosslinking agents, whitening agents such as TiO₂ and ZnO, UV absorbers, hindered amine light stabilizers, defoaming agents, processing aids, surfactants, and other conventional additives may be added to the intermediate layer compositions used in the invention. In addition, antioxidants, stabilizers, softening agents, plasticizers, including internal and external plasticizers, impact modifiers, foaming agents, density-adjusting fillers, reinforcing materials, and compatabilizers may also be added to any of the intermediate layer compositions. One of ordinary skill in the art should be aware of the requisite amount for each type of additive to realize the benefits of that particular additive.

Cover Composition and construction

The cover 106 for a golf ball of the present invention may be formed in any way known in the art, including, but not limited to compression molding, injection molding, RPIM, injection compression molding, reaction injection molding, or casting. The cover 106 disposed about the golf ball subassembly 112 may be a soft cover formed of a material with a hardness of less than about 70 Shore D. A very low modulus ionomer (VLMI) can be used to make a cover 106 with a low compression, i.e., a soft “feel.” U.S. Pat. No. 4,431,193, incorporated herein by reference relates to a golf ball having a multilayer cover wherein the inner cover is a hard, high flexural modulus ionomeric resin and the outer cover is a soft, low flexural modulus ionomeric resin. While the VLMI provides a soft cover, the coefficient of restitution may be also low. Thus, in a preferred aspect of the present invention, blends of ionomers and nonionomers, e.g., grafted metallocene-catalyzed polyolefins, such as those disclosed in U.S. Pat. No. 6,800,690, incorporated herein by reference in its entirety, are used to produce soft cover layers in golf balls. Less material is typically required to obtain the desired degree of softness when FUSABOND® (commercially available from E. I. DuPont de Nemours & Co. of Wilmington, Del.) is used as a cover layer as compared to a VLMI resin. FUSABOND® is a series of maleic anhydride grafted ethylene-butene or ethylene-octene metallocene catalyzed copolymers having flexural modulus values between about 2000 psi and 3000 psi. The use of FUSABOND®, or a similar material, results in a golf ball with a good balance of speed and spin. Due to the hydrophobic nature of the polymer backbone, however, it is essential that good mixing is achieved to enhance compatibility between FUSABOND® and conventional ionomers and to avoid processing problems. Moreover, there is increased potential for delamination due the metallocene's absorption of moisture.

Further suitable cover materials can include any known to those of ordinary skill in the art, including but not limited to, one or more homopolymeric or copolymeric materials, such as:

(1) Vinyl resins, such as those formed by the polymerization of vinyl chloride, or by the copolymerization of vinyl chloride with vinyl acetate, acrylic esters or vinylidene chloride;
(2) Polyolefins, such as polyethylene, polypropylene, polybutylene and copolymers such as ethylene methylacrylate, ethylene ethylacrylate, ethylene vinyl acetate, ethylene methacrylic or ethylene acrylic acid or propylene acrylic acid and copolymers and homopolymers produced using a single-site catalyst;
(3) Polyurethanes, such as those prepared from polyols and diisocyanates or polyisocyanates and those disclosed in U.S. Pat. No. 5,334,673;
(4) Polyureas, such as those disclosed in U.S. Pat. No. 5,484,870;
(5) Polyamides, such as poly(hexamethylene adipamide) and others prepared from diamines and dibasic acids, as well as those from amino acids such as poly(caprolactam), and blends of polyamides with SURLYN® ionomer (commercially available from E. I. DuPont de Nemours & Co. of Wilmington, Del.), polyethylene, ethylene copolymers, ethyl-propylene-non-conjugated diene terpolymer, and the like;
(6) Acrylic resins and blends of these resins with polyvinyl chloride, elastomers, and the like;
(7) Thermoplastics, such as urethanes; olefinic thermoplastic rubbers, such as blends of polyolefins with ethylene-propylene-non-conjugated diene terpolymer; block copolymers of styrene and butadiene, isoprene or ethylene-butylene rubber; or copoly(ether-amide), such as PEBAX, sold by ELF Atochem of Philadelphia, Pa.;
(8) Polyphenylene oxide resins or blends of polyphenylene oxide with high impact polystyrene as sold under the trademark NORYL® by General Electric Company of Pittsfield, Mass.;
(9) Thermoplastic polyesters, such as polyethylene terephthalate, polybutylene terephthalate, polyethylene terephthalate/glycol modified and elastomers sold under the trademarks HYTREL® by E. I. DuPont de Nemours & Co. of Wilmington, Del., and LOMOD® by General Electric Company of Pittsfield, Mass.;
(10) Blends and alloys, including polycarbonate with acrylonitrile butadiene styrene, polybutylene terephthalate, polyethylene terephthalate, styrene maleic anhydride, polyethylene, elastomers, and the like, and polyvinyl chloride with acrylonitrile butadiene styrene or ethylene vinyl acetate or other elastomers; and
(11) Blends of thermoplastic rubbers with polyethylene, propylene, polyacetal, nylon, polyesters, cellulose esters, and the like.
(12) Solvent and suspension based latexes of polyisoprene or polybutadiene.
(13) Reactive resins, such as epoxies, polyesters, and polyamides.

Dimples

The cover layer 106 may have dimples on its surface. The use of various dimple patterns and profiles provides a relatively effective way to modify the aerodynamic characteristics of a golf ball. As such, the manner in which the dimples are arranged on the surface of the ball can be by any available method. For instance, the ball may have an icosahedron-based pattern, such as described in U.S. Pat. No. 4,560,168, or an octahedral-based dimple patterns as described in U.S. Pat. No. 4,960,281.

In one embodiment of the present invention, the golf ball has an icosahedron dimple pattern that includes 20 triangles made from about 362 dimples and, except perhaps for the cover parting line, does not have a great circle that does not intersect any dimples. Each of the large triangles, preferably, has an odd number of dimples (7) along each side and the small triangles have an even number of dimples (4) along each side. To properly pack the dimples, the large triangle has nine more dimples than the small triangle. In another embodiment, the ball has five different sizes of dimples in total. The sides of the large triangle have four different sizes of dimples and the small triangles have two different sizes of dimples.

In another embodiment of the present invention, the golf ball has an icosahedron dimple pattern with a large triangle including three different dimples and the small triangles having only one diameter of dimple. In a preferred embodiment, there are 392 dimples and one great circle that does not intersect any dimples. In another embodiment, more than five alternative dimple diameters are used.

In one embodiment of the present invention, the golf ball has an octahedron dimple pattern including eight triangles made from about 440 dimples and three great circles that do not intersect any dimples. In the octahedron pattern, the pattern includes a third set of dimples formed in a smallest triangle inside of and adjacent to the small triangle. To properly pack the dimples, the large triangle has nine more dimples than the small triangle and the small triangle has nine more dimples than the smallest triangle. In this embodiment, the ball has six different dimple diameters distributed over the surface of the ball. The large triangle has five different dimple diameters, the small triangle has three different dimple diameters and the smallest triangle has two different dimple diameters.

Alternatively, the dimple pattern can be arranged according to phyllotactic patterns, such as described in U.S. Pat. No. 6,338,684, which is incorporated herein in its entirety.

Dimple patterns may also be based on Archimedean patterns including a truncated octahedron, a great rhombcuboctahedron, a truncated dodecahedron, and a great rhombicosidodecahedron, wherein the pattern has a non-linear parting line, as disclosed in U.S. Pat. No. 6,705,959, which is incorporated by reference herein.

The golf balls of the present invention may also be covered with non-circular shaped dimples, i.e., amorphous shaped dimples, as disclosed in U.S. Pat. No. 6,409,615, which is incorporated in its entirety by reference herein.

Dimple patterns that provide a high percentage of surface coverage are preferred, and are well known in the art. For example, U.S. Pat. Nos. 5,562,552, 5,575,477, 5,957,787, 5,249,804, and 4,925,193 disclose geometric patterns for positioning dimples on a golf ball. In one embodiment, the golf balls of the invention have a dimple coverage of the surface area of the cover of at least about 60 percent, preferably at least about 65 percent, and more preferably at least 70 percent or greater. Dimple patterns having even higher dimple coverage values may also be used with the present invention. Thus, the golf balls of the present invention may have a dimple coverage of at least about 75 percent or greater, about 80 percent or greater, or even about 85 percent or greater.

In addition, a tubular lattice pattern, such as the one disclosed in U.S. Pat. No. 6,290,615, which is incorporated by reference in its entirety herein, may also be used with golf balls of the present invention. The golf balls of the present invention may also have a plurality of pyramidal projections disposed on the cover layer of the ball, as disclosed in U.S. Pat. No. 6,383,092, which is incorporated in its entirety by reference herein. The plurality of pyramidal projections on the golf ball may cover between about 20 percent to about 80 of the surface of-the cover layer.

In an alternative embodiment, the golf ball may have a non-planar parting line allowing for some of the plurality of pyramidal projections to be disposed about the equator. Such a golf ball may be fabricated using a mold as disclosed in U.S. Pat. No. 6,632,078, which is incorporated in its entirety by reference herein. This embodiment allows for greater uniformity of the pyramidal projections.

Several additional non-limiting examples of dimple patterns with varying sizes of dimples are also provided in U.S. Pat. No. 6,358,161 and U.S. Pat. No. 6,213,898, the entire disclosures of which are incorporated by reference herein.

The total number of dimples on the ball, or dimple count, may vary depending on such factors as the dimple size and the selected pattern. In general, the total number of dimples on the ball preferably is between about 100 to about 1000 dimples, although one skilled in the art would recognize that differing dimple counts within this range can significantly alter the flight performance of the ball. In one embodiment, the dimple count is about 380 dimples or greater, but more preferably is about 400 dimples or greater, and even more preferably is about 420 dimples or greater. In one embodiment, the dimple count on the ball is about 422 dimples. In some cases, it may be desirable to have fewer dimples on the ball. Thus, one embodiment of the present invention has a dimple count of about 380 dimples or less, and more preferably is about 350 dimples or less.

Dimple profiles revolving a catenary curve about its symmetrical axis may increase aerodynamic efficiency, provide a convenient way to alter the dimples to adjust ball performance without changing the dimple pattern, and result in uniformly increased flight distance for golfers of all swing speeds. Thus, catenary curve dimple profiles, as disclosed in U.S. Pat. No. 6,796,912, which is incorporated in its entirety by reference herein, is contemplated for use with the golf balls of the present invention.

While the preferred embodiments of the present invention have been described above, it should be understood that they have been presented by way of example only, and not of limitation. It will be apparent to persons skilled in the relevant art that various changes in form and detail can be made therein without departing from the spirit and scope of the invention. For example, while the preferred non-planar shapes have been provided above, other non-planar shapes could also be used. Thus the present invention should not be limited by the above-described exemplary embodiments, but should be defined only in accordance with the following claims and their equivalents.

1. A golf ball, comprising:
a subassembly comprising at least a core;
an intermediate layer disposed around the subassembly, wherein the intermediate layer comprises a non-planar parting line; and
a cover comprising a planar parting line.

2. The golf ball of claim 1, wherein the intermediate layer comprises a compression molding layer made from pre-formed blanks.

3. The golf ball of claim 1, wherein the intermediate layer comprises an injection molding layer.

4. The golf ball of claim 1, wherein the intermediate layer comprises a reaction product of a polyol and an isocyanate.

5. The golf ball of claim 1, wherein the planar parting line of the cover layer is misaligned with the non-planar parting line of the intermediate layer.

6. The golf ball of claim 1, wherein the non-planar parting line comprises a plurality of alternating peaks and troughs

7. The golf ball of claim 1, wherein the non-planar parting line comprises a sinusoidal shape, a square wave, a jagged shape or a triangular wave.

8. The golf ball of claim 1, wherein the intermediate layer is compression molded and the non-planar parting line comprises an approximately sinusoidal shape.

9. A method of injection molding an outer layer surrounding a golf ball subassembly comprising the steps of:
providing a mold made from two mold-halves with a non-planar parting line wherein the mold comprises a first set of vents and a second set of vents, said first vents are located proximate to the peaks of the parting line and said second vents are located proximate to the troughs of the parting line,
locating the mold around the golf ball assembly,
injecting molten material into a polar gate in each mold-half, and
allowing the molten materials to meet proximate the parting line to form said outer layer.

10. The method of claim 10, wherein the first vents are located substantially on the peaks of the parting line and the second vents are located substantially on the troughs of the parting line.

11. The method of making a golf ball of claim 17, wherein at least one of the vents is an elongated vent.
